(19) United States
(12) Patent Application Publication
(10) Pub. No.: US 2026/0235459 A1
(43) Pub. Date: Aug. 13, 2026

(54) APPLICATOR SYSTEM FOR ATTACHING SENSORS TO SURFACES

(71) Applicant: WATRING TECHNOLOGIES, INC., HUNTSVILLE, AL (US)

(72) Inventors: ELIJAH JAMES SCHULDT, HUNTSVILLE, AL (US); JERROD BLAKE BOUCHARD, HUNTSVILLE, AL (US)

(21) Appl. No.: 19/051,394

(22) Filed: Feb. 12, 2025

(51) Int. Cl. G01L 1/22; B29C 65/00; B29C 65/48

(52) U.S. Cl. CPC G01L 1/2206; B29C 65/4835; B29C 66/82423

(57) ABSTRACT

An applicator system designed for attaching sensors, such as a strain gauge, to surfaces includes an applicator cup made from flexible material, featuring a recess on its bottom surface. The system is equipped with a vacuum pump that is in fluid communication with the recess to create a vacuum, and a heating element associated with the applicator cup.

### BACKGROUND

### Field

The present disclosure relates generally to sensors, and in particular, to attaching sensors, such as strain gauges, to surfaces.

### Description of the Problem and Related Art

Strain gauges are essential tools in various engineering applications, used to measure the amount of strain on an object. They are crucial in fields such as aerospace, civil engineering, and mechanical engineering, where precise measurements can inform safety and performance decisions. The application of strain gauges typically requires a meticulous process to ensure accurate readings, which includes the proper curing of the resin used to adhere the gauges to surfaces. This curing process often demands specific temperature profiles to ensure the resin bonds correctly, which can be challenging to achieve with conventional methods like ovens or heat lamps, especially in complex or confined environments.

Traditional methods for applying strain gauges have faced several limitations. These include the inability to maintain a consistent temperature profile necessary for optimal resin curing, difficulties in applying gauges to non-horizontal or irregular surfaces, and challenges in accessing tight spaces. Additionally, previous methods often relied on inferior adhesives or cumbersome equipment that could not provide the precision or flexibility required for certain applications. As industries continue to push the boundaries of technology and design, there is a growing need for more adaptable and precise solutions to overcome these challenges in strain gauge application.

### SUMMARY

For purposes of summary, certain aspects, advantages, and novel features are described herein. It is to be understood that not necessarily all such advantages may be achieved in accordance with any one particular embodiment. Thus, the apparatuses or methods claimed may be embodied or carried out in a manner that achieves or optimizes one advantage or group of advantages as taught herein without necessarily achieving other advantages as may be taught or suggested herein.

In accordance with embodiments, an applicator system is provided for attaching sensors to a surface. The system comprises an applicator cup formed from a flexible material and having a recess defined into a bottom surface of the applicator cup. A vacuum pump is in fluid communication with the recess for creating a vacuum within the recess, and a heating element is associated with the applicator cup.

In accordance with other embodiments, the applicator system further comprises a controller configured to regulate a temperature within the recess, wherein the heating element is responsive to the controller. The controller may also monitor air pressure within the recess.

In yet other embodiments, the applicator system includes an applicator cup that comprises a temperature sensor in communication with the controller.

In further embodiments, the applicator system comprises a plurality of applicator cups responsive to the controller, each of the applicator cups in fluid communication with the vacuum pump.

In additional embodiments, the controller is configured to allow a user to define a temperature profile within the recess.

In accordance with other embodiments, the sensor is a strain gauge.

In yet other embodiments, the applicator system further comprises a controller configured to regulate a temperature within the recess, wherein the heating element is responsive to the controller, specifically for the strain gauge.

In further embodiments, the applicator system includes an applicator cup that comprises a temperature sensor in communication with the controller, specifically for the strain gauge. Additionally, the system comprises a plurality of applicator cups responsive to the controller, each of the applicator cups in fluid communication with the vacuum pump, specifically for the strain gauge.

In accordance with embodiments, a method is provided for attaching sensors to a surface. The method involves associating a sensor with the surface using an adhesive and curing the adhesive with heat within a vacuum formed in a recess defined in an applicator cup. The applicator cup is made of a flexible material, allowing it to conform to the surface and create a vacuum seal for effective curing of the adhesive.

In accordance with other embodiments, the method further includes overlaying a sensor with the applicator cup such that the sensor is enclosed within the recess. This ensures that the adhesive is cured in a controlled environment, enhancing the bond between the sensor and the surface.

In yet other embodiments, the method includes regulating the heat according to a user-defined temperature profile. This allows for precise control over the curing process, ensuring that the adhesive is cured optimally for the specific type of sensors and surface involved.

In further embodiments, the applicator cup comprises a heating element for adding heat to the space within the recess. This built-in heating element provides a consistent and controlled source of heat, facilitating the curing process and improving the reliability of the attachment.

In additional embodiments, the sensor is specified as a strain gauge. This highlights the method's applicability to precise measurement devices, where secure attachment is critical for accurate readings.

In another embodiment, the method involves a plurality of sensors devices, with each device associated with its own applicator cup. This allows for simultaneous attachment of multiple devices, each with its own controlled curing environment, ensuring consistent and reliable attachment across all devices.

### BRIEF DESCRIPTION OF THE DRAWINGS

The system and method are described with reference to the accompanying drawings. In the drawings, like reference numbers indicate identical or functionally similar elements. Additionally, the left-most digit(s) of a reference number identifies the drawing in which the reference number first appears.

FIG. 1 is a functional schematic of an exemplary sensor applicator system;

FIG. 2 is a plan view of the bottom side of an exemplary applicator cup;

FIG. 3 illustrates overlaying the applicator cup onto a surface for attaching a sensor device;

FIG. 4 is a flow chart depicting a method for using the applicator system of FIG. 1; and

FIG. 5 is a functional schematic of another embodiment of a sensor applicator system.

### DETAILED DESCRIPTION

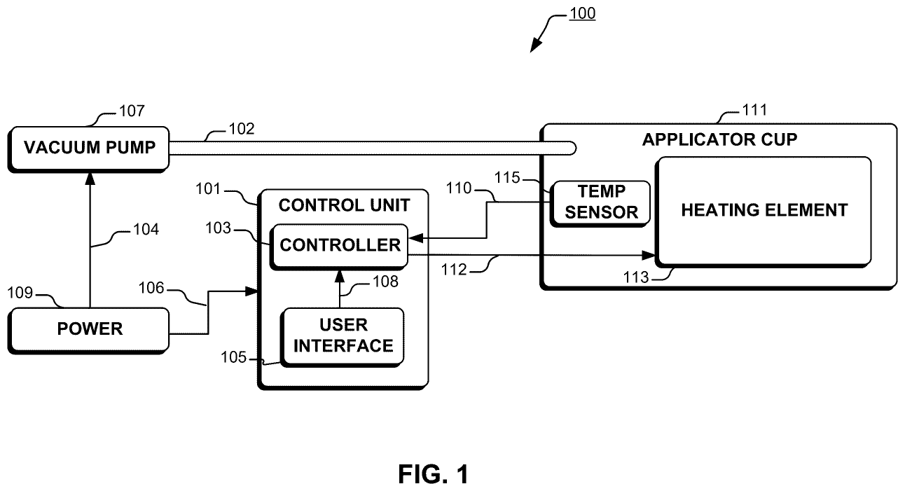

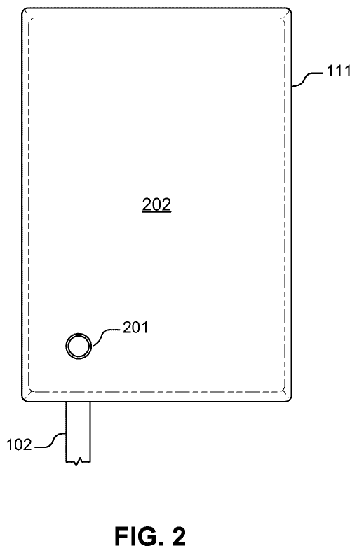

The various embodiments of the applicator system and their advantages are best understood by referring to FIGS. 1 through 5 of the drawings. The elements of the drawings are not necessarily to scale, emphasis instead being placed upon clearly illustrating the novel features and principles of operation. Throughout the drawings, like numerals are used for like and corresponding parts of the various drawings.

Furthermore, reference in the specification to “an embodiment,” “one embodiment,” “various embodiments,” or any variant thereof means that a particular feature or aspect described in conjunction with the particular embodiment is included in at least one embodiment. Thus, the appearance of the phrases “in one embodiment,” “in another embodiment,” or variations thereof in various places throughout the specification are not necessarily all referring to its respective embodiment.

Referring to FIGS. 1 through 3, the system 100 comprises an applicator cup 111, that may be constructed from a flexible material, allowing it to adhere to irregular and curved surfaces. This flexibility ensures proper contact and adhesion when attaching sensors, such as, for a non-limiting example, strain gauges, to various surfaces. It will be understood that the present disclosure contemplates a variety of sensors that are configured to be attached or associated to surfaces may be used.

Applicator cup 111 may be formed from silicone, rubber, a polymeric, or other suitable flexible substance that can retain its characteristics in extreme temperatures. Applicator cup 111 may include a recess 202 which is in fluid communication with a vacuum pump 107 through vacuum line 102. For this reason, the bottom side of applicator cup 111 is configured with a vacuum port 201 defined therein which is in fluid communication with vacuum line 102.

Applicator cup 111 may also be associated with a heating element 113, which responds to a controller 103 within a control unit 101. This heating element 113 allows for the application of a temperature curing profile required for the proper adhesion of strain gauges. The heating element's 113 responsiveness to the controller 103 enables precise temperature regulation within the recess 202, which is important for maintaining the required temperature profile for curing the resin used in the application of strain gauges. This precise temperature control is further enhanced by the inclusion of a temperature sensor 115, which communicates with the controller 103 to monitor and adjust the temperature as needed. Temperature sensor 115 relays signals 110 representing temperature within recess 202 to controller 103. Control unit 101 is also configured with a user interface 105 for allowing a user to define a temperature profile specific to the sensor adhesive being used. The system further includes a power supply 109 for providing power 104 to vacuum pump 107 and power 106 to control unit 101. Control unit may relay power 112 to heating element 113. Power may be provided as any suitable voltage, including 110, 120, 208, or 240 VAC.,

The system 100 facilitates the application of strain gauges without the need for gravity or wrapping materials, allowing for application on any surface orientation. The ability to follow a specific temperature curve enables the use of an adhesive, ensuring a strong bond between the strain gauge and the surface. The flexibility of the applicator cup, combined with its heating capabilities, provides a versatile solution for attaching sensors in challenging environments where conventional methods may be inadequate.

Controller 103 regulates the temperature within the recess of the applicator system. This regulation is achieved through communication with temperature sensor 115, which monitors the temperature to ensure it aligns with a user-defined programmable temperature curve. The controller allows for user customization, enabling the definition of specific temperature profiles necessary for the curing of resin used in the application of strain gauges. This capability facilitates the proper adhesion of strain gauges on various surfaces, even in orientations that do not rely on gravity or require wrapping materials. Controller 103 also maintains a historical record of the temperature applied during the curing process, providing an accurate account of the temperature profile followed. The temperature sensor 115 plays a role in this process by continuously communicating the temperature data 110 to the controller, ensuring precise temperature regulation. This system allows for the application of strain gauges without the need for conventional heating methods, such as ovens, and is particularly beneficial in locations where such methods are impractical. The flexibility of the applicator cups, in conjunction with the controller's capabilities, enables the system to adhere to irregular and curved surfaces under vacuum pressure, ensuring bonding of the strain gauges.

Controller 103, as will be appreciated by those skilled in the arts, may be one or more computer-based processors. Such a processor may be implemented by a programmable logic circuit (PLC), field programmable gated array (FPGA), application specific integrated chip (ASIC), programmable circuit board (PCB), or other suitable integrated chip (IC) device.

A processor in effect comprises a computer system. Such a computer system includes, for example, one or more central processing units (CPUs) that are connected to a communication bus. The computer system can also include a main memory, such as, without limitation, flash memory, read-only memory (ROM), or random access memory (RAM), and can also include a secondary memory. The secondary memory can include, for example, a hard disk drive and/or a removable storage drive. The removable storage drive reads from and/or writes to a removable storage unit in a well-known manner. The removable storage unit, represents a floppy disk, magnetic tape, optical disk, and the like, which is read by and written to by the removable storage drive. The removable storage unit includes a computer usable storage medium having stored therein computer software and/or data.

The secondary memory can include other similar means for allowing computer programs or other instructions to be loaded into the computer system. Such means can include, for example, a removable storage unit and an interface. Examples of such can include a program cartridge and cartridge interface (such as that found in video game devices), a removable memory chip (such as an EPROM, or PROM) and associated socket, and other removable storage units and interfaces which allow software and data to be transferred from the removable storage unit to the computer system.

Computer programs (also called control logic) are stored in the main memory and/or secondary memory. Computer programs can also be received via the communications interface. Such computer programs, when executed, enable the computer system to perform certain features of the present invention as discussed herein. In particular, the computer programs, when executed, enable a control processor to perform and/or cause the performance of features of the present invention. Accordingly, such computer programs represent controllers of the computer system.

A processor, and the processor memory, may advantageously contain control logic or other substrate configuration representing data and instructions, which cause the processor to operate in a specific and predefined manner as, described hereinabove. The control logic may advantageously be implemented as one or more modules. The modules may advantageously be configured to reside on the processor memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and the like. Control logic may be installed on the memory using a computer interface couple to the communication bus which may be any suitable input/output device. The computer interface may also be configured to allow a user to vary the control logic, either according to pre-configured variations or customizably.

The control logic conventionally includes the manipulation of data bits by the processor and the maintenance of these bits within data structures resident in one or more of the memory storage devices. Such data structures impose a physical organization upon the collection of data bits stored within processor memory and represent specific electrical or magnetic elements. These symbolic representations are the means used by those skilled in the art to effectively convey teachings and discoveries to others skilled in the art.

The control logic is generally considered to be a sequence of processor-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, records, files, or the like. It should be kept in mind, however, that these and some other terms should be associated with appropriate physical quantities for processor operations, and that these terms are merely conventional labels applied to physical quantities that exist within and during operation of the computer.

It should be understood that manipulations within the processor are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the processor or computers.

It should also be understood that the programs, modules, processes, methods, and the like, described herein are but an exemplary implementation and are not related, or limited, to any particular processor, apparatus, or processor language. Rather, various types of general purpose computing machines or devices may be used with programs constructed in accordance with the teachings described herein. Similarly, it may prove advantageous to construct a specialized apparatus to perform the method steps described herein by way of dedicated processor systems with hard-wired logic or programs stored in nonvolatile memory, such as, by way of example, read-only memory (ROM), for example, components such as ASICs, FPGAs, PCBs, microcontrollers, or multi-chip modules (MCMs). Implementation of the hardware state machine so as to perform the functions described herein will be apparent to persons skilled in the relevant art(s).

In an embodiment where the system is implemented using software, the software can be stored in a computer program product and loaded into the computer system using the removable storage drive, the memory chips or the communications interface. The control logic (software), when executed by a control processor, causes the control processor to perform certain functions of the system as described herein.

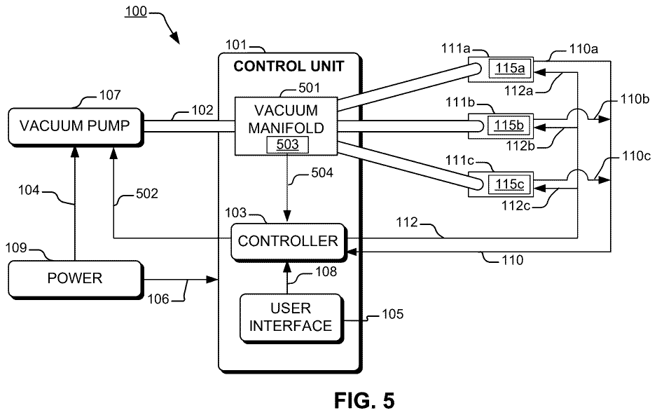

With reference to FIG. 5, in some embodiments, system 100 may support a plurality of applicator cups 111a-c. In such embodiments, system 100 is provided with a vacuum manifold 501 which is configured to allow pump 107 to be in fluid communication with the recess of each applicator cup 111a-c via vacuum lines 506a-c. Advantageously, manifold 501 includes sensor(s) 503 for detecting pressure within lines 506a-c and their associated recesses. Sensor(s) 503 are responsive to controller 103 providing signals representing pressures 504 for each applicator 111a-c. In response to the signal(s) controller 103 issues a control signal 502 to vacuum pump 107 to maintain vacuum for each applicator 111a-c. In another embodiment, there is not a feedback signal 502 to the vacuum pump 107. In such case, if sensor(s) 503 detect that vacuum pressure in applicator cup 111a-c has been released, controller 103 is configured to issue an alert to an operator who manually turns on vacuum pump 107.

As described above, applicators 111a-c are each configured with temperature sensors 115a-c which relay signals 110a-c representing temperature within applicator recesses. In response, controller 103 transmits control signals 112 to the respective heating elements of each applicator (not shown).

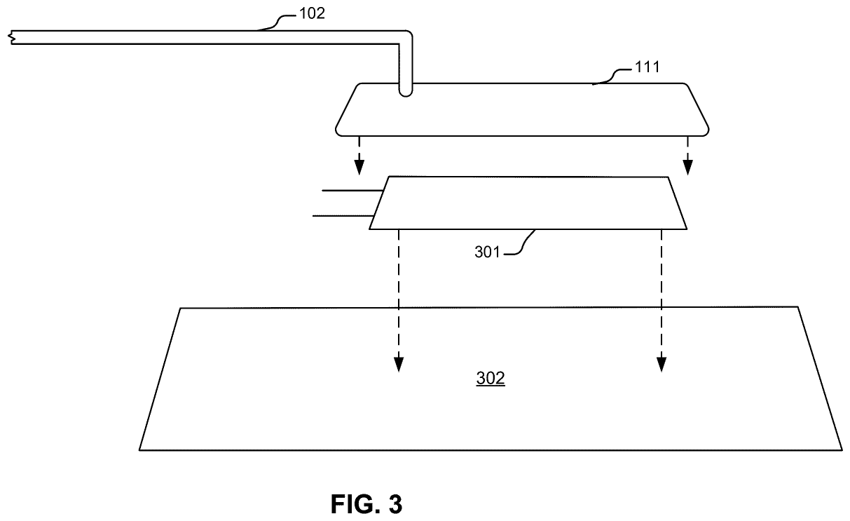

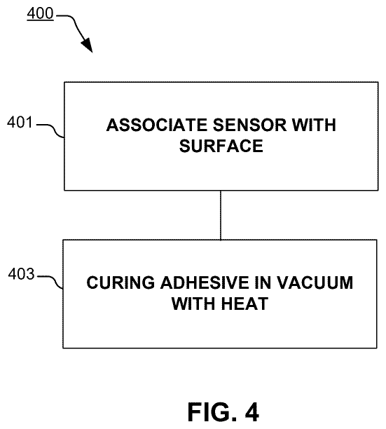

A method for attaching sensors to a surface is illustrated by the flowchart shown in FIG. 4 and with reference to FIG. 3. At step 401, the sensor 301 may be associated with the surface 302 using an adhesive. At step 403, the adhesive may be cured with heat within a vacuum, which may be facilitated by heated application cup 111. Applicator cup 111 may allow for the application of a temperature curing profile to properly adhere the strain gauges on various surfaces. The curing process may involve regulating the heat according to a user-defined temperature profile, ensuring that the temperature is maintained accurately along the interface surface. Applicator cup 111 may comprise a heating element 113 for adding heat. The sensor 301 may be overlaid with applicator cup 111, enclosing it within the recess 202. This enclosure may be beneficial for adhering the sensor on irregular and curved surfaces, thanks to the flexibility of the applicator cup 111. The system may also allow for the application of several strain gauges simultaneously, accommodating various gage sizes and applicator cup sizes. This method may provide a record of the actual temperature at the surface, ensuring that the required temperature is maintained throughout the curing process.

As described above and shown in the associated drawings, the present invention comprises an applicator system for attaching a sensor to a surface. While particular embodiments have been described, it will be understood, however, that any invention appertaining to the system and method described is not limited thereto, since modifications may be made by those skilled in the art, particularly in light of the foregoing teachings. It is, therefore, contemplated by the appended claims to cover any such modifications that incorporate those features or those improvements that embody the spirit and scope of the invention.

What is claimed is:

1. An applicator system for attaching a sensor to a surface, the system comprising:
an applicator cup formed from a flexible material and having a recess defined into a bottom surface the applicator cup;
a vacuum pump in fluid communication with the recess for creating a vacuum within the recess; and
a heating element associated with the applicator cup.

2. The applicator system of claim 1, further comprising a controller configured to regulate at least one of a temperature and a pressure within the recess, wherein the heating element and/or the vacuum pump is responsive to the controller.

3. The applicator system of claim 2, wherein the applicator cup comprises a temperature sensor in communication with the controller.

4. The applicator system of claim 2, comprising a plurality of applicator cups responsive to the controller, each of the applicator cups in fluid communication with the vacuum pump through a manifold.

5. The applicator system of claim 4, wherein the manifold comprises one or more pressure sensors for detecting pressure within each recess, and wherein the controller is responsive to signals representing pressure from the pressure sensors.

6. The applicator system of claim 2, wherein the controller is configured to allow a user to define a temperature profile within the recess.

7. The applicator system of claim 1, wherein the sensor is a strain gauge.

8. The applicator system of claim 7, further comprising a controller configured to regulate at least one of a temperature and a pressure within the recess, wherein the heating element and/or the vacuum pump is responsive to the controller.

9. The applicator system of claim 7, wherein the applicator cup comprises a temperature sensor in communication with the controller.

10. The applicator system of claim 7, comprising a plurality of applicator cups responsive to the controller, each of the applicator cups in fluid communication with the vacuum pump through a manifold.

11. A method for attaching a sensor to a surface, the method comprising the steps of:
associating the sensor with the surface using an adhesive; and
curing the adhesive with heat within a vacuum formed within a recess defined in an applicator cup, the applicator cup formed of a flexible material.

12. The method of claim 10, wherein the step of curing the adhesive comprises overlaying the sensor with the applicator cup such that the sensor is enclosed within the recess.

13. The method of claim 11, further comprising the step of regulating the heat according to a user-defined temperature profile.

14. The method of claim 10, wherein the applicator cup comprises a heating element for adding heat to space within the recess.

15. The method of claim 10, wherein the sensor is a strain gauge.

16. The method of claim 14, wherein the sensor is a plurality of sensors devices and wherein each sensors device is associated with an applicator cup.

17. The method of claim 11, further comprising maintaining a historical record of the temperature applied during step of curing the adhesive.

18. A system for adhering a strain gauge to a surface comprising:
a controller having a user interface;
one or more applicator cups, each applicator cup formed from a flexible material and having a recess defined in the bottom surface thereof, and having a heating element responsive to the controller for heating the recess;
a vacuum pump in fluid communication with each of the one or more the recesses.

19. The system of claim 16, comprising a plurality of applicator cups responsive to the controller, each of the applicator cups in fluid communication with the vacuum pump through a manifold.

20. The system of claim 17, wherein the applicator cup comprises a temperature sensor in communication with the controller and the manifold comprises a pressure sensor in communication with the controller.

21. The system of claim 16, wherein the user interface is configured to allow a user to define a temperature profile for the recess.
